(19) United States
(12) Patent Application Publication
(10) Pub. No.: US 2014/0089814 A1
(43) Pub. Date: Mar. 27, 2014

(54) METHOD FOR POSTING MICROBLOG TOPIC AND TERMINAL

(71) Applicant: TENCENT TECHNOLOGY (SHENZHEN) COMPANY LIMITED, Shenzhen City (CN)

(72) Inventors: Wenlin YU, Shenzhen City (CN); Yupeng GAO, Shenzhen City (CN)

(73) Assignee: TENCENT TECHNOLOGY (SHENZHEN) COMPANY LIMITED, Shenzhen City (CN)

(21) Appl. No.: 14/094,123

(22) Filed: Dec. 2, 2013

Related U.S. Application Data
(63) Continuation of application No. PCT/CN2012/087551, filed on Dec. 26, 2012.

(30) Foreign Application Priority Data
Dec. 29, 2011 (CN) 201110451679.2

(51) Int. Cl. H04L 12/58

(52) U.S. Cl. CPC H04L 51/00
USPC 715/752

(57) ABSTRACT

Described is a method for posting a microblog topic. The method includes: receiving a trigger for an operation of a topic; acquiring a preset default topic; displaying the preset default topic in an input box of a microblog; receiving content to be posted; receiving a trigger for an operation of a post; determining whether a topic currently displayed in the input box of the microblog is the preset default topic; and posting the content to be posted with the preset default topic if the topic currently displayed in the input box of the microblog is determined as the preset default topic. The method is capable of increasing the user's participation in discussing the topic.

### CROSS REFERENCE TO RELATED APPLICATION

This application is a continuation of International Application No. PCT/CN2012/087,551 filed on Dec. 26, 2012. This application claims the benefit and priority of Chinese Application No. 201110451679.2, filed on Dec. 29, 2011. The entire disclosure of each of the above applications is incorporated herein by reference.

### TECHNICAL FIELD

The present disclosure relates to a field of terminal operations, and more particularly to a method for posting a microblog topic and a terminal.

### BACKGROUND

In products such as Qzone, microblog et al, a written operation mode is usually formed by content aggregation in the same topic. When a user clicks a “topic” button in an input box of a microblog, a default guidance prompt “#please input a topic you want to write#” is displayed. The user can input a topic he/she wants to write about between the # signs, input content to be posted corresponding to the topic in the input box of the microblog, and post the content to be posted with the topic.

In the above-mentioned method of posting the topic, there is not a prompt about a topic for the user. When the user's awareness is not high enough, the user does not understand which topic is currently most discussed by others and does not understand what to write about after the user clicks the topic button. As a result, the user's ability to participate in topics of discussion is lower, and the user's experience is worse.

### SUMMARY OF THE DISCLOSURE

The embodiments of the present disclosure provide a method for posting a microblog topic and a terminal capable of increasing the user's participation in discussing the topic, thereby raising the quality of the user's experience.

To achieve the above-mentioned objective, the embodiments of the present disclosure adopt the following technical schemes.

A method for posting a microblog topic, comprising:

receiving a trigger for an operation of a topic;

acquiring a preset default topic according to the trigger;

displaying the preset default topic in an input box of a microblog;

receiving content to be posted which is inputted in the input box of the microblog by a user;

determining whether a topic currently displayed in the input box of the microblog is the preset default topic; and

posting the content to be posted with the preset default topic if the topic currently displayed in the input box of the microblog is determined as the preset default topic.

The preset default topic is displayed at an input start position in the input box of the microblog, and the input start position is at a left end or a right end in the input box of the microblog.

A method for posting a microblog topic, comprising:

receiving a trigger for an operation of a topic;

acquiring a preset default topic;

displaying the preset default topic in an input box of a microblog;

receiving content to be posted which is inputted in the input box of the microblog by a user;

receiving a trigger for an operation of a post of the content;

determining whether a topic currently displayed in the input box of the microblog is determined as the preset default topic; and

posting the content to be posted with the preset default topic if the topic currently displayed in the input box of the microblog is determined as the preset default topic.

A terminal, comprising:

a first acquiring unit configured to acquire a preset default topic after a trigger for an operation of a topic is received;

a display unit configured to display the preset default topic in an input box of a microblog;

a receiving unit configured to receive content to be posted which is inputted in the input box of the microblog by a user;

a determination unit configured to determine whether a topic currently displayed in the input box of the microblog is determined as the preset default topic; and

a posting unit configured to post the content to be posted with the preset default topic after a trigger for an operation of a post is received and the topic currently displayed in the input box of the microblog is determined as the preset default topic by the determination unit.

In the method for posting the microblog topic provided by the embodiments of the present disclosure, after the trigger for the operation of the topic is received, the preset default topic is displayed in the input box of the microblog, so that the user can conveniently discuss the preset default topic. Moreover, after the trigger for the operation of the post is received and the topic currently displayed in the input box of the microblog is determined as the preset default topic, posting the content to be posted directly with the preset default topic is beneficial for the user, as it allows the user to discuss the same topic as others, rather than posting content divergently and aimlessly. As a result, it is convenient for the user's operations, and the user's participation in topic discussion is increased, thereby improving the user's experience.

### BRIEF DESCRIPTION OF THE DRAWINGS

To clarify the embodiments of the present disclosure or technical schemes in the prior art, the appended drawings required in the descriptions of the embodiments and the prior art are briefly described as follows. The following drawings merely illustrate some embodiments of the present disclosure. For those skilled in the art, other drawings may be acquired according to the drawings without devoting effort.

FIG. 1 is a schematic diagram illustration of a flowchart of a method for posting a microblog topic in accordance with one embodiment of the present disclosure;

FIG. 2 is a schematic diagram illustration of a flowchart of a method for posting a microblog topic in accordance with another embodiment of the present disclosure;

FIG. 3 is a schematic diagram illustration of a default topic displayed in an input box of a microblog in accordance with the embodiment in FIG. 2 of the present disclosure;

FIG. 4 is a schematic diagram illustration of a block diagram of a terminal in accordance with yet another embodiment of the present disclosure;

FIG. 5 is a schematic diagram illustration of a block diagram of another terminal in accordance with the embodiment in FIG. 3 of the present disclosure; and

FIG. 6 is a schematic diagram illustration of a block diagram of another terminal in accordance with the embodiment in FIG. 3 of the present disclosure.

### DETAILED DESCRIPTION OF THE DISCLOSURE

The technical scheme provided in embodiments of the present disclosure will be clearly and completely described below with reference to the accompanying drawings. It should be appreciated that the embodiments described herein are merely part of, but not all of, the possible embodiments of the present disclosure, and that other embodiments devised by those of ordinary skill in the art based on the embodiments herein without making creative efforts are within the protection scope of the present disclosure.

The following description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules may be executed using a single (shared) processor. In addition, some or all code from multiple modules may be stored by a single (shared) memory. The term “group”, as used herein, means that some or all code from a single module may be executed using a group of processors. In addition, some or all code from a single module may be stored using a group of memories.

The systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

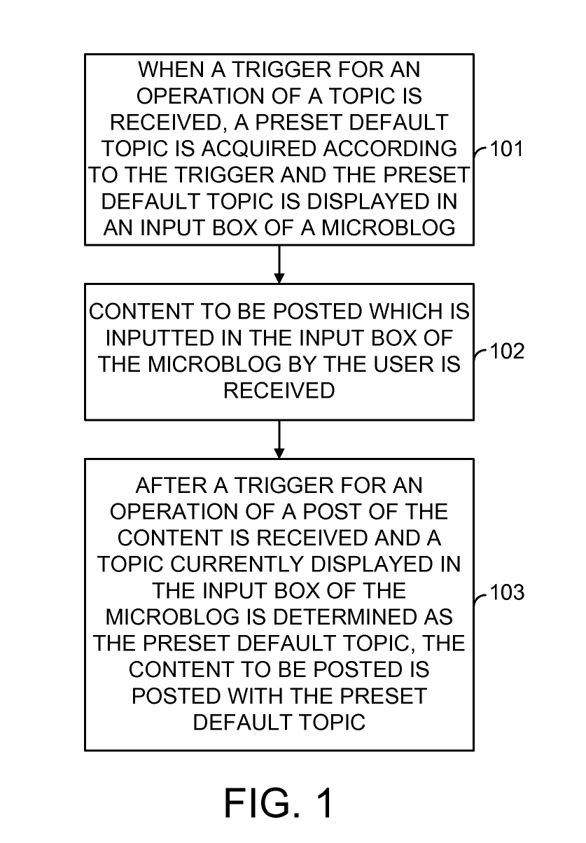

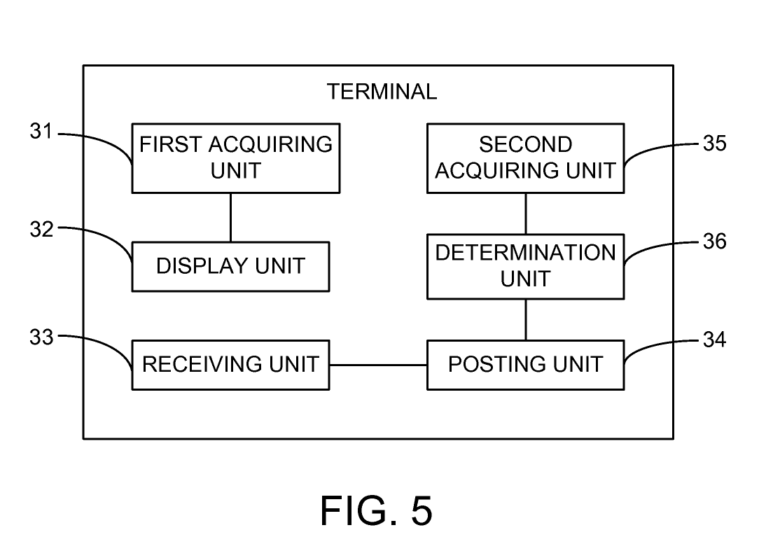

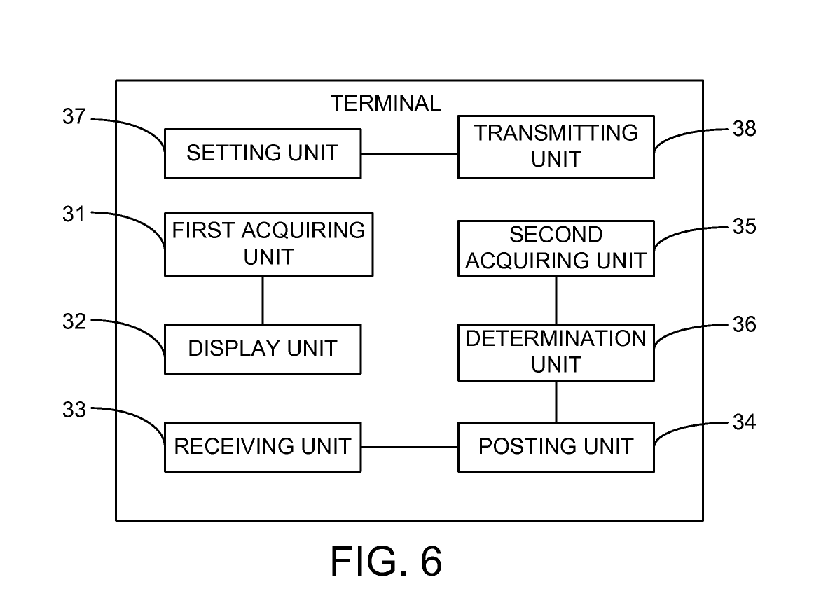

The description will be made as to the embodiments of the present invention in conjunction with the accompanying drawings in FIGS. 1-6. It should be understood that specific embodiments described herein are merely intended to explain the present invention, but not intended to limit the present invention.

### Embodiment 1

The embodiment of the present disclosure provides a method for posting a microblog topic. As shown in FIG. 1, the method comprises the following steps.

In step 101, when a trigger for an operation of a topic is received, a preset default topic is acquired according to the trigger and the preset default topic is displayed in an input box of a microblog. The preset default topic may be displayed at any one position in the input box of the microblog. For example, the preset default topic is displayed at an input start position in the input box of the microblog. The start position may be at the left end (subject to Chinese, English et al.) or the right end (subject to Hebrew et al.).

The operation of the topic may be, but is not limited to being, triggered with an action of clicking a “topic” button by a user. For example, the operation of the topic may be triggered according to the user's voice input. That is, whether the voice input indicates to trigger the operation of the topic is determined according to the voice input after acquiring the user's voice input. If yes, the operation of the topic is triggered. The default topic may be a currently hot topic. The preset default topic may also be a topic preseted by an administrator, a topic preseted by the user and so on, but it is not limited to methods in the embodiment of the present disclosure and may be one of any concerned topics, for example, a topic generated by a random method and so on.

Furthermore, before the preset default topic is acquired, the preset default topic is required to be set in the input box of the microblog and the preset default topic is transmitted to a server, such that the server records the setting of the preset default topic. When the trigger for the operation of the topic is received, the preset default topic is acquired from the server.

In step 102, content to be posted which is inputted in the input box of the microblog by the user is received.

In step 103, after a trigger for an operation of a post of the content is received and a topic currently displayed in the input box of the microblog is determined as the preset default topic, the content to be posted is posted with the preset default topic.

In the embodiment of the present disclosure, after the trigger for the operation of the topic is received, the preset default topic is displayed in the input box of the microblog, so that the user can conveniently discuss the preset default topic. Moreover, after the trigger for the operation of the post of the content is received and the topic currently displayed in the input box of the microblog is determined as the preset default topic, posting the content to be posted with the preset default topic directly is beneficial for the user, as it allows the user to discuss the same topic as others, rather than posting content divergently and aimlessly. As a result, it is convenient for the user's operations, and the user's participation in topic discussion is increased, thereby improving the user's experience.

### Embodiment 2

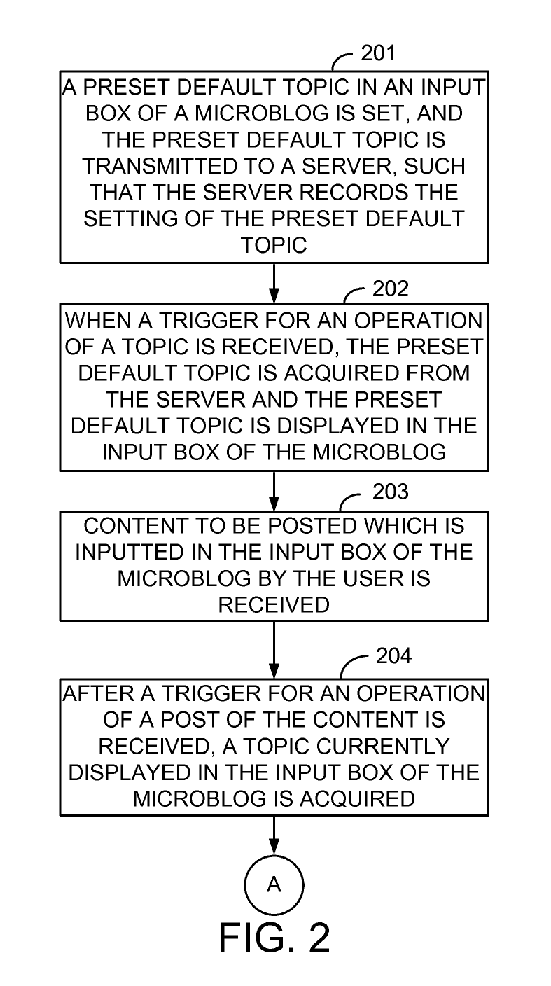

The embodiment of the present disclosure provides a method for posting a microblog topic. As shown in FIG. 2, the method comprises the following steps.

In step 201, a preset default topic in an input box of a microblog is set, and the preset default topic is transmitted to a server, such that the server records the setting of the preset default topic.

The preset default topic may be a currently hot topic, but it is not limited to such in the embodiment of the present disclosure and may be any one of the concerned topics. For example, during a university entrance examination, a hot topic which concerns everyone is the university entrance examination. Accordingly, the preset default topic may be set as “something about the university entrance examination”.

Moreover, the preset default topic in the input box of the microblog may be set by a manager, but it is not limited to such in the embodiment of the present disclosure and may be set by another device.

In step 202, when a trigger for an operation of a topic is received, the preset default topic is acquired from the server according to the trigger and the preset default topic is displayed in the input box of the microblog.

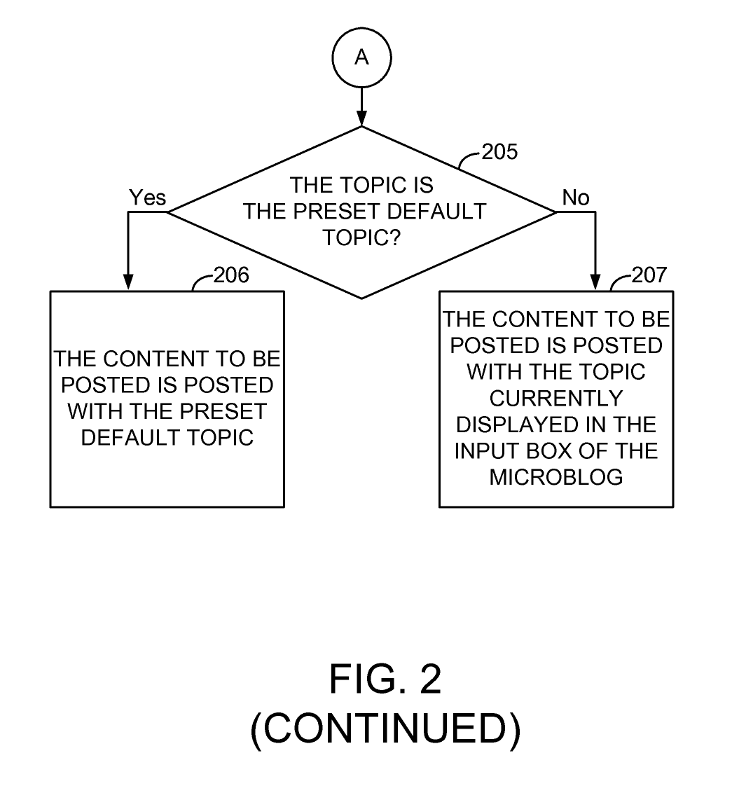

The operation of the topic may be, but is not limited to being, triggered with an action of clicking a “topic” button by a user. For example, the operation of the topic may be triggered according to the user's voice input. That is, whether the voice input indicates to trigger the operation of the topic is determined according to the voice input after acquiring the user's voice input. If yes, the operation of the topic is triggered. Taking the preset default topic “something about the university entrance examination” in step 201 for example, after the user clicks a “topic” button, the preset default topic is displayed in the input box of the microblog as shown in FIG. 3.

In step 203, content to be posted which is inputted in the input box of the microblog by the user is received.

In step 204, after a trigger for an operation of a post of the content is received, a topic currently displayed in the input box of the microblog is acquired.

It is noted that the user may not be interested in the preset default topic after the preset default topic is displayed in the input box of the microblog. The user may modify the preset topic in the input box of the microblog manually. Accordingly, after the trigger for the operation of the post of the content is received, the topic currently displayed in the input box of the microblog is required to be acquired firstly, so as to determine whether the user modifies the preset default topic.

In step 205, it is determined whether the topic currently displayed in the input box of the microblog is the preset default topic. If the topic currently displayed in the input box of the microblog is the preset default topic, it represents that the user does not modify the preset default topic and then step 206 is performed. If the topic currently displayed in the input box of the microblog is not the preset default topic, it represents that the user modifies the preset default topic and then step 207 is performed.

By acquiring the topic currently displayed in the input box of the microblog and determining whether the topic currently displayed in the input box of the microblog is the preset default topic, it helps to prevent the preset topic from being changed before the content to be posted is posted, and it is beneficial to ensure the consistency of the topic discussed by the user.

In step 206, the content to be posted is posted with the preset default topic.

In step 207, the content to be posted is posted with the topic currently displayed in the input box of the microblog.

In the embodiment of the present disclosure, when the trigger for the operation of the topic is received, the preset default topic is displayed in the input box of the microblog, such that the user can conveniently discuss the preset default topic. Moreover, after the trigger for the operation of the post of the content is received and the topic currently displayed in the input box of the microblog is determined as the preset default topic, posting the content to be posted with the preset default topic directly is convenient for the user's operations, and the user's participation in topic discussion is increased, thereby improving the user's experience. A shortcut method for providing a topic function for the user to utilize decreases a threshold of a written operation.

Moreover, when the user is not interested in the preset default topic, the user may modify the preset topic in the input box of the microblog and post the content to be posted with the modified topic. Accordingly, it is convenient for the user's operations, and the user's experience is improved.

### Embodiment 3

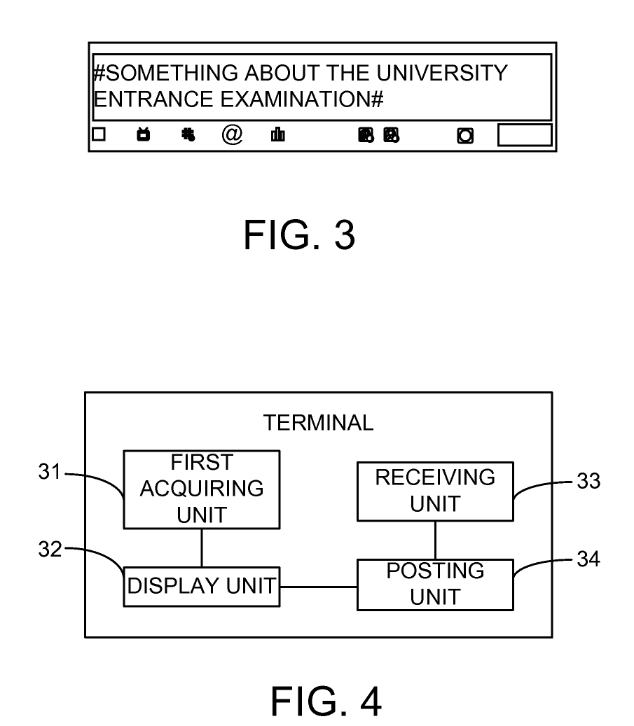

The embodiment of the present disclosure provides a terminal. As shown in FIG. 4, the terminal comprises a first acquiring unit 31, a display unit 32, a receiving unit 33 and a posting unit 34.

The first acquiring unit 31 is configured to acquire a preset default topic after a trigger for an operation of a topic is received. The operation of the topic may be, but is not limited to being, triggered by clicking a “topic” button by a user. For example, the operation of the topic may be triggered according to the user's voice input. That is, whether the voice input indicates to trigger the operation of the topic is determined according to the voice input after acquiring the user's voice input. If so, the operation of the topic is triggered.

The display unit 32 is configured to display the preset default topic in an input box of a microblog.

The receiving unit 33 is configured to receive content to be posted which is inputted in the input box of the microblog by the user.

The posting unit 34 is configured to post the content to be posted with the preset default topic after a trigger for an operation of a post of the content is received and a topic currently displayed in the input box of the microblog is determined as the preset default topic.

It is noted that the user may not be interested in the preset default topic after the preset default topic is displayed in the input box of the microblog. The user may modify the preset default topic in the input box of the microblog manually. Accordingly, after the trigger for the operation of the post is received, the topic currently displayed in the input box of the microblog is required to be acquired firstly, so as to determine whether the user modifies the preset default topic. Moreover, the terminal further comprises a second acquiring unit 35 and a determination unit 36.

The second acquiring unit 35 is configured to acquire the topic currently displayed in the input box of the microblog after the trigger for the operation of the post of the content is received.

The determination unit 36 is configured to determine whether the topic currently displayed in the input box of the microblog is the preset default topic.

The posting unit 34 is further configured to post the content to be posted with the topic currently displayed in the input box of the microblog if the topic currently displayed in the input box of the microblog is not determined as the preset default topic and, thus, it represents that the user modifies the preset default topic.

By acquiring the topic currently displayed in the input box of the microblog and determining whether the topic currently displayed in the input box of the microblog is the preset default topic, it helps to prevent the preset default topic from being changed before the content to be posted is posted, and it helps to ensure the consistency of the topic discussed by the user.

Moreover, the terminal further comprises a setting unit 37 and a transmitting unit 38.

The setting unit 37 is configured to set the preset default topic in the input box of the microblog before the first acquiring unit 31 acquires the preset default topic. The preset default topic may be a currently hot topic, but it is not limited to such in the embodiment of the present disclosure and may be one of any concerned topics. For example, during a university entrance examination, a hot topic which concerns everyone is the university entrance examination. Accordingly, the preset default topic may be set as “something about the university entrance examination”.

The transmitting unit 38 is configured to transmit the preset default topic to a server, such that the server records the setting of the preset default topic.

The first acquiring unit 31 is further utilizing for acquiring the preset default topic from the server after the trigger for the operation of the topic is received.

In the method for posting the microblog topic and the terminal, according to the embodiments of the present disclosure, when the trigger for the operation of the topic is received, the preset default topic is displayed in the input box of the microblog, so that the user can conveniently discuss the preset default topic. Moreover, after the trigger for the operation of the post is received and the topic currently displayed in the input box of the microblog is determined as the preset default topic, posting the content to be posted with the preset default topic directly is convenient for the user's operations, and the user's participation in topic discussion is increased, thereby improving the user's experience. A shortcut method of providing a topic function for the user to utilize decreases a threshold of a written operation.

Moreover, when the user is not interested in the preset default topic, the user may modify the preset default topic in the input box of the microblog and post the content to be posted with the modified topic. Accordingly, it is convenient for the user's operations, and the user's experience is improved.

It should be appreciated by those skilled in the art that all or part of the steps of the method described in the embodiments above may be executed by relevant hardware instructed by a program or by hardware, and the prior one is a preferred method in many situations. When the program is performed, the steps of the method described in the embodiments are performed. Based on such understanding, the essentially technical schemes of the present disclosure or the contribution over the prior art may be executed by software products. The computer software products are stored in a computer-readable memory medium, such as a soft disk of a computer, a magnetic disk, a compact disc, and so on, and they include codes for a computer device (may be a personal computer, a server or a net device) to perform the methods in accordance with the embodiments of the present disclosure.

It should be noted that the embodiments described above are merely preferred ones of the present disclosure but are not limitations to the protection scope of the present disclosure, and any variations or substitutions easily devised by those skilled in the art without departing from the spirit of the present disclosure fall within the scope of the protection. Therefore, the protection scope of the present disclosure shall be subject to that specified by the appended claims.

What is claimed is:

1. A method for posting a microblog topic, comprising:
receiving a trigger for an operation of a topic;
acquiring a preset default topic according to the trigger;
displaying the preset default topic in an input box of a microblog, wherein the preset default topic is displayed at an input start position in the input box of the microblog, and the input start position is at a left end or a right end in the input box of the microblog;
receiving content to be posted which is inputted in the input box of the microblog by a user;
receiving a trigger for an operation of a post of the content;
determining whether a topic currently displayed in the input box of the microblog is the preset default topic; and
posting the content to be posted with the preset default topic if the topic currently displayed in the input box of the microblog is determined as the preset default topic.

2. The method according to claim 1, wherein after the step of receiving the trigger for the operation of the post of the content, the method further comprises:
acquiring the topic currently displayed in the input box of the microblog.

3. The method according to claim 1, further comprising:
posting the content to be posted with the topic currently displayed in the input box of the microblog if the topic currently displayed in the input box of the microblog is not the preset default topic.

4. The method according to claim 1, wherein after the step of receiving the trigger for the operation of the topic, the method further comprises:
setting the preset default topic in the input box of the microblog; and
transmitting the preset default topic to a server, such that the server records the setting of the preset default topic.

5. The method according to claim 4, wherein the preset default topic is acquired from the server.

6. The method according to claim 1, wherein the operation of the topic is triggered by a user's clicking action or a user's voice input.

7. A method for posting a microblog topic, comprising:
receiving a trigger for an operation of a topic;
acquiring a preset default topic according to the trigger;
displaying the preset default topic in an input box of a microblog;
receiving content to be posted which is inputted in the input box of the microblog by a user;
receiving a trigger for an operation of a post of the content;
determining whether a topic currently displayed in the input box of the microblog is determined as the preset default topic; and
posting the content to be posted with the preset default topic if the topic currently displayed in the input box of the microblog is determined as the preset default topic.

8. The method according to claim 7, wherein after the step of receiving the trigger for the operation of the post of the content, the method further comprises:
acquiring the topic currently displayed in the input box of the microblog.

9. The method according to claim 7, further comprising:
posting the content to be posted with the topic currently displayed in the input box of the microblog if the topic currently displayed in the input box of the microblog is not the preset default topic.

10. The method according to claim 7, wherein after the step of receiving the trigger for the operation of the topic, the method further comprises:
setting the preset default topic in the input box of the microblog; and
transmitting the preset default topic to a server, such that the server records the setting of the preset default topic.

11. The method according to claim 10, wherein the preset default topic is acquired from the server.

12. The method according to claim 11, wherein the operation of the topic is triggered by a user's clicking action or a user's voice input.

13. A terminal, comprising:
a first acquiring unit configured to acquire a preset default topic after a trigger for an operation of a topic is received;
a display unit configured to display the preset default topic in an input box of a microblog;
a receiving unit configured to receive content to be posted which is inputted in the input box of the microblog by a user;
a determination unit configured to determine whether a topic currently displayed in the input box of the microblog is determined as the preset default topic; and
a posting unit configured to post the content to be posted with the preset default topic after a trigger for an operation of a post of the content is received and the topic currently displayed in the input box of the microblog is determined as the preset default topic by the determination unit.

14. The terminal according to claim 13, further comprising:
a second acquiring unit configured to acquire the topic currently displayed in the input box of the microblog after the trigger for the operation of the post of the content is received.

15. The terminal according to claim 13, wherein the posting unit is further configured to post the content to be posted with the topic currently displayed in the input box of the microblog if the topic currently displayed in the input box of the microblog is not determined as the preset default topic by the determination unit.

16. The terminal according to claim 13, further comprising:
a setting unit configured to set the preset default topic in the input box of the microblog before the first acquiring unit acquires the preset default topic; and
a transmitting unit configured to transmit the preset default topic to a server, such that the server records the setting of the preset default topic.

17. The terminal according to claim 16, wherein the first acquiring unit is further configured to acquire the preset default topic from the server after the trigger for the operation of the topic is received.

18. The terminal according to claim 13, wherein the operation of the topic is triggered by a user's clicking action or a user's voice input.
